(19) United States
(12) Patent Application Publication
(10) Pub. No.: US 2006/0066802 A1
(43) Pub. Date: Mar. 30, 2006

(54) Reflective electrophoretic display device with improved contrast

(75) Inventor: Hiroyuki Kitayama, Isehara-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Ohta-ku (JP)

(21) Appl. No.: 10/536,747

(22) PCT Filed: Mar. 17, 2004
(86) PCT No.: PCT/JP04/03584

§ 371 Date: May 27, 2005

(30) Foreign Application Priority Data
Mar. 18, 2003 (JP) 2003-073272

(51) Int. Cl. G02F 1/1339

(52) U.S. Cl. 349/156

(57) ABSTRACT

A reflection display device that comprises a display substrate and a rear substrate disposed with a predetermined space; a transparent liquid disposed in the space between the substrates; a partition wall formed from a material capable of transmit light and disposed between the substrates; a shielding layer disposed between the partition wall and the rear substrate; and a light scattering layer disposed on the rear substrate, wherein a refractive index of the partition wall is larger than that of the transparent liquid, a refractive index of the partition wall is larger than that of the transparent liquid, and among light rays incident on the display substrate at a predetermined incident angle or more, a light ray that enters the partition wall is not totally reflected but refracted at a side of the partition wall, whereby having an enhanced reflectance.

### TECHNICAL FIELD

The present invention relates to a reflection display device including a transparent liquid as a display medium.

### BACKGROUND ART

With advance in information technology devices, needs for thin displays with low power consumption are increasing, and the development and research work of the display devices to meet these needs are extensively conducted. Above all, crystal liquid display devices have been actively developed and commercialized as the display devices capable of meeting such needs. However, there is a problem with the current display devices that letters on the screen become hard to see depending on the viewing angle or due to the reflected light, and further, there is another problem of heavy stress to the eye due to the flickering or low luminance of the light source, and such problems are not yet sufficiently solved. Hence, novel reflection display devices are counted on from the viewpoint of low power consumption, less stress to the eye and the like.

As a reflection display device other than the liquid crystal display device, there is the electrophoretic display device that displays by moving charged particles in a transparent insulating liquid.

This electrophoretic display device, for example, as proposed in U.S. Pat. No. 3,612,758, is constituted of a pair of substrates spaced at a predetermined interval, and in the space between these substrates, there are disposed the insulating liquid and the charged particles. The device is structured such that the charged particles migrate when a voltage is applied to a pair of electrodes disposed in the vicinity of the insulating liquid.

In such an electrophoretic display device, there is a need for the charged particles not to freely move to other pixels from the standpoint of quality of the display, and U.S. Pat. No. 6,327,072 or U.S. Pat. No. 6,639,580 has proposed a device provided with a partition wall at the pixel boundary so as to prevent the movement of the charged particles.

When an electrophoretic display device as described above is used as the reflection display device, there is a problem that the reflectance of white display is as low as about 20 to 30%, in comparison with about 55% of the white portion of printed matters, and the display is difficult to see.

Thus, an object of the present invention is to provide an electrophoretic display device that prevents lowering of the optical reflectance.

### DISCLOSURE OF THE INVENTION

The present invention has been made in view of the above-described circumstances. The display device of the present invention comprises a display substrate and a rear substrate disposed with a space; a transparent liquid disposed in the space between these substrates; a partition wall formed from a material capable of transmitting light and disposed in the space between the substrates; a light shielding layer disposed between the partition wall and the rear substrate; and a light scattering layer disposed on the rear substrate capable of reflecting an incident light from outside the display substrate, and the device is characterized in that a refractive index of the partition wall is no less than that of the transparent liquid, and an incident light ray on the display substrate at a predetermined incident angle or more that enters inside the partition wall is not totally reflected but refracted into the transparent liquid at a side face of the partition wall.

According to the present invention, the light reflectance can be improved in the reflection display device.

### BRIEF DESCRIPTION OF THE DRAWINGS

FIG. 1 is a sectional view showing one example of the structure of an electrophoretic display device according to the present invention;

FIG. 2 is a sectional view for explaining the incidence and reflection of light;

FIG. 3 is a sectional view for explaining the incidence and reflection of light;

FIG. 4 is a schematic illustration for explaining Snell's law and Fresnel's formula; and

FIG. 5 is a schematic illustration for explaining measurement of the reflection angle etc.

### BEST MODE FOR CARRYING OUT THE INVENTION

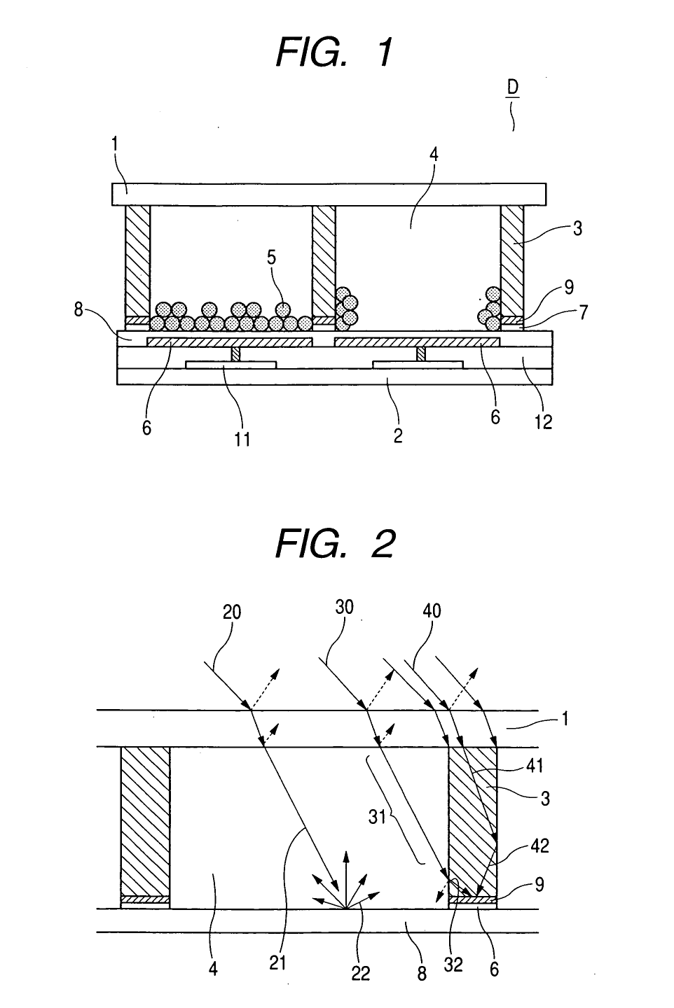

An embodiment of the present invention will be described below with reference to FIGS. 1 to 4.

An electrophoretic display device according to the present invention, as shown in FIG. 1 with a reference symbol D, comprises a display substrate 1 and a rear substrate 2 spaced at a predetermined distance, a partition wall 3 disposed between these substrates 1 and 2, an insulating liquid 4 and a plurality of charged particles 5 disposed in the space between these substrates 1 and 2, a first electrode 6 disposed in the vicinity of the insulating liquid 4, and a second electrode 7 disposed so as to contact the partition wall 3.

This electrophoretic display device is a so-called reflection display, and is structured such that the display substrate 1 is transparent to permit incident light, and the incident light is reflected by the rear substrate 2. In other words, the display substrate 1 in the present description is a substrate disposed on the viewer's side, and the other substrate is a “rear substrate”. That is, the electrophoretic display device according to the present embodiment performs display in such a manner that the charged particles 5 migrate on application of a voltage to the electrodes 6 and 7, and at the same time, the incident light is reflected.

The method for reflecting the light on the rear substrate 2 can be:

providing a light scattering layer or a light reflection layer (reference numeral 8 of FIG. 1) on the rear substrate 2, or

using the first electrode 6 provided on the rear substrate 2 as a light scattering layer.

Further, the above-described partition wall 3 made of a material that passes light is structured so as to shield a part where the second electrode 7 is disposed from light. Such a shield is necessary for increasing the amount of the incident light onto the light scattering layer 8, so as to further improve luminosity and contrast of the display, to prevent color mixing in color display, to shield a switching element from light, and the like.

To shield from light the part where the second electrode 7 is disposed, there are methods such as:

providing a shielding layer 9 so as to cover the second electrode 7, and

using the second electrode 7 as the shielding layer.

In the electrophoretic display device shown in FIG. 1, the first electrode 6 as well as the second electrode 7 is supported by the rear substrate 2. That is, the device is a “lateral migration” type in which the charged particles 5 move between the first electrode 6 and the second electrode 7 along the rear substrate 2. Other than this type, there is available an electrophoretic display device of “non-lateral migration” type in which the charged particles 5 move in a direction vertical to the substrate, but since the present invention is for increasing a reflectance of the light reflected from the rear substrate surface, the invention is applied to the lateral migration type.

With a lateral migration type display where a region in which the first electrode 6 is disposed is white, and the charged particles 5 are black,

white color is displayed when the charged particles 5 are drawn to the second electrode 7, and

black color is displayed when the charged particles 5 are drawn to the first electrode 6.

Although the description will be made below with the electrophoretic display device as an example, the present invention is applicable to any display device so long as it is a display device using a transparent liquid and reflection at the rear substrate. Thus the display dvice may be an ordinary crystal liquid display device.

Conditions for increasing the reflectance will be described in the following (1) to (7):

(1) Constitution of the Electrophoretic Display Device

In general, the partition wall 3 is disposed in the space between substrates of the electrophoretic display device in order to prevent the charged particles from migrating to other pixels with segment drive or matrix drive, that is, in order to prevent deviation of the charged particles between pixels. Further, the light scattering layer 8 is formed on the rear substrate 2, and the electrode 7 disposed between the partition wall 3 and the rear substrate 2 is provided with a shielding layer 9.

The partition wall 3 is composed of an optically transparent material so as to make the amount of the incident light onto the rear substrate as large as possible. The shielding layer 9 absorbs light incident vertically onto the substrate, and when the partition wall 3 does not transmit the light, the wall 3 also absorb the light incident with an angle, so that the light reaching the rear substrate is extremely reduced. Hence, no matter how high the reflectance of the light scattering layer 8 of the rear substrate is made, the reflectance as a whole substrate does not increase. In order to brighten the display using the angled incident light efficiently, the partition wall must be transparent.

(2) Light Path

In such an electrophoretic display device, there are various paths of the irradiated and reflected light such as (2-1) to (2-4), and some light enters into the interior of the partition wall.

(2-1) Incident Light Along Path 20 in FIG. 2

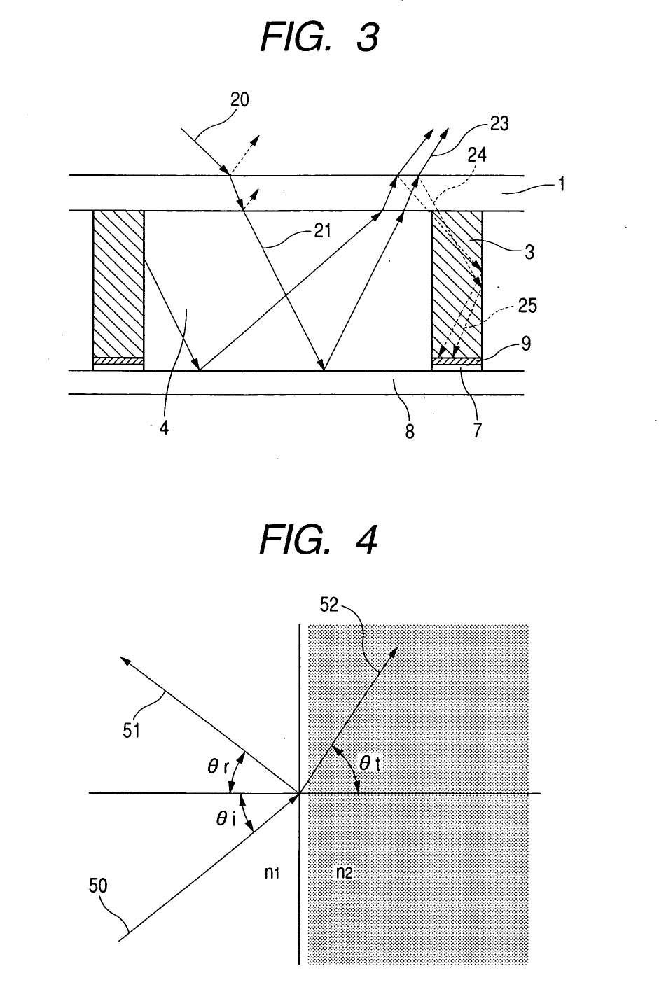

As shown in FIG. 2, the incident light 20 is slightly refracted in the substrate 1, and passes through the insulating liquid 4 and reaches the light scattering layer 8 as the incident light 21, which is then diffuse-reflected at the scattering layer 8 (reflected light 22). Among the diffuse reflection light, the light that passes through again the insulating liquid 4 and the display substrate 1 (light 23 in FIG. 3) serves for display recognition.

A part of the light passing through the liquid is reflected at the surface of the display substrate (light 24 in FIG. 3) and enters the partition wall 3. It is totally reflected at the wall and absorbed by the light shielding layer 9 (light 25 in FIG. 3).

(2-2) Incident Light 30 in FIG. 2

The incident light along the path 30 passes through the insulating liquid 4 (light 31) and enters into the partition wall 3.

(2-3) Incident Light Along the Path Shown by Reference Numeral 40 in FIG. 2

The light incident along the path of the reference numeral 40 does not enter into the insulating liquid 4, but enters into the partition wall 3 (the reference numeral 41).

(2-4) Light Diffuse-Reflected in (2-1)

The light 22 diffuse-reflected as described above (2-1) takes a path, for example, as shown with reference numeral 23 in FIG. 3 and passes the display substrate 1. However, about 5 to 6% of the light is reflected at a boundary surface between the display substrate 1 and the air as shown by reference numeral 24.

Such reflection light 24 may enter into the partition wall 3 as illustrated, depending on the position and reflection angle.

(3) Light Entered Into the Partition Wall

Among the light as described above, the light of (2-2) to (2-4) enters into the partition wall.

Among the light entered the wall 3, the light of reference numeral 32 is absorbed by the shielding layer 9, and the lights shown by reference numerals 41 and 24 are totally reflected at the wall surface of the partition wall 3, and finally absorbed by the shielding layer 9 (see reference numerals 42 and 25).

(4) Conditional Formula for the Total Reflection at the Wall Surface of the Partition Wall 3

Here is considered the total reflection of the light 41 and 24 incident in the partition wall 3 at the wall surface of the partition wall 3.

In general, in the boundary surface (see FIG. 4) of media differing in the index of refraction, Snell's law:
n₁ sin θᵢ=n₂ sin θᵢ (Formula 1),
Fresnel's formula: (with natural light)

$$\begin{matrix}{R}_{n} = \frac{1}{2} [ {\{ \frac{tan ( {θ}_{i} - {θ}_{t} )}{tan ( {θ}_{i} + {θ}_{t} )} \}}^{2} + {\{ \frac{sin ( {θ}_{i} - {θ}_{t} )}{sin ( {θ}_{i} + {θ}_{t} )} \}}^{2} ] , and & ( Formula 2 ) \\ {T}_{n} = 1 - {R}_{n} & ( Formula 3 )\end{matrix}$$

are established. Here, Rn is transmittance, and Tn is reflectance. Reference numeral 50 in FIG. 4 denotes an incident light, reference numeral 51 a reflected light, and reference numeral 52 a transmitted light. Further, θi denotes an incident angle, and θr denotes a reflection angle, and θt denotes a transmission angle. Further, n1 denotes the refractive index of the first medium from which the light exits and enters the second medium, and n2 denotes the refractive index of the second medium.

Here, when Snell's law is applied for the light 41 incident on the partition wall 3 as described above, usually the refractive index of the insulating liquid 4 is about 1.42, and the refractive index of the partition wall 3 is about 1.59. Hence, by substituting these values, one can know that the total reflection will occur in the interior of the partition wall.

(5) Influence of the Total Reflection

When the light is totally reflected inside of the partition wall as described above, the light once enters the partition wall is absorbed by the shielding layer 9, and does not contribute to the reflection. As described above, this is one of the causes to lower the reflectance of the light. When the light reflectance of white display was actually measured, it was about 20% to 30%.

That is, when the total reflection occurs in the interior of the partition wall, the reflectance of the light is lowered much.

(6) Condition for Preventing Total Reflection

When the following conditional formula 1
n(K)<n(L) [Conditional Formula 1]
(where n(K) is the refractive index of the wall and n(L) is the refractive index of the liquid) is satisfied, no total reflection occurs in the interior of the partition wall. However, the liquid ordinarily used in the electrophoretic display device is a hydrocarbon organic solvent, and its refractive index is about 1.4, while the partition wall is made of a macromolecular material such as epoxy resin, and its refractive index is about 1.5. Hence, this condition is not satisfied. A higher refractive index of the liquid member than the present level directly affects other performance as a display device, and not preferable. Further, it is difficult to lower the refractive index of the partition wall in view of material selection.
(7) Condition for Preventing Total Reflection

On the other hand, in case of n(K)≧n(L), the total reflection condition at the boundary between the partition wall and the liquid becomes: θₜ=Arc sin [n(L)/n(K)]. The incident light at an angle larger than this angleθₜ is totally reflected in the partition wall, the incident light at an angle smaller than θₜ is refracted when it hits the side of the partition wall, and a part of the light goes out to the next pixel.

According to the following consideration, it has become possible to make a major part of the light incident on the display substrate not totally reflected.

As described above, in the light incident on the display substrate, the light directly incident on the partition wall as shown by reference numeral 40 of FIG. 2 is responsible for the lowering of the reflectance. Among the incident light, the light at a vertical or near vertical incident angle is directly absorbed by the shielding layer, thus not serving as the reflection light.

When the incident angle becomes large to some extent, the light enters in the partition wall as shown by optical paths 41 and 42. Supposing that the incident angle of the vertical incidence is 0°, light incident at the incident angle 30° is considered.

The incident angle of a light transmitting the display substrate and incident to the partition wall is expressed as follows when the horizontal direction is taken as 0°:
90°−Arc sin [sin 30°/n(K)].

A condition for not causing total reflection in the partition wall when this light hits on the side of the partition wall is as follows:

ti 90°−Arc sin [sin 30°/n(K)]<θₜ.

After all, one can understand that the following formula is established as a relationship between the partition wall and the refractive index of the liquid:
90°−Arc sin [½/n(K)]<Arc sin [n(L)/n(K)] [Conditional Formula 2]

For example, when n(K)=1.59 and n(L)=1.42, the conditional formula 2 is not satisfied, and the total reflection occurs.

However, when n(K)=1.50, the conditional formula 2 is satisfied, and total reflection does not occur.

In other words, according to the present invention, the refractive index is set in such a manner that, in the light incident on the display substrate, the light directly incident into the partition wall comes out into the liquid from the side of the partition wall. By so doing, among the light rays incident on the display substrate, a light ray incident at an angle larger than a certain angle (e.g., 30° according to the above explanation), that is, incident more obliquely, enters the partition wall at a smaller angle not to cause total reflection in the partition wall, and is refracted to come out into the liquid. The light coming out into the liquid is incident on the scattering layer of the next pixel and is reflected, and thus contributes to the brightness. The light having a smaller incident angle is, in the first place, directly incident on the shielding layer in its majority, and hence does not contribute to reflection.

When the conditional formula 2 is drawn, the incident angle to the display substrate contributing to reflectance was set as not less than 30°. However, this angle can be appropriately determined from the height H and width W of the partition wall. This angle may be determined on the basis of the angle range at which at least part of the light incident on the display substrate directly reaches the shielding layer provided at the bottom of the partition wall, without reflected at the side of the partition wall. That is, it may be decided not less than:
Arc sin (n(K)sinα).

Here, tan

$$α = \frac{W}{H} .$$

Next, each member of the electrophoretic display device will be supplementally described below.

The partition wall 3 may be disposed so as to enclose pixels one by one or disposed so as to enclose a plurality of pixels at a time. For the partition wall 3, a material having a refractive index as small as possible and being a photosensitive resin such as epoxy, polyimide, acryl and the like may be used. However, its refractive index needs not to be smaller than that of the insulating liquid.

For the display substrate 1 and the rear substrate 2, glass, quartz and the like can be used as well as plastic film such as polyethylene terephthalate (PET), polycarbonate (PC), polyether sulphone (PET) and the like. The display substrate 1, as described above must be a transparent material, while the rear substrate 2 can be a material colored with polyimide (PT) and the like.

For the first electrode 6, any material may be used as long as it is a conductive material capable of patterning. For example, a metal such as chrome (Cr), aluminum (AI), cupper (Cu) and the like or carbon and silver paste or an organic conductive film can be used. When the first electrode is also used as a light reflection layer, a material having a high reflectance such as silver (Ag) or AI and the like is preferably used.

While the second electrode 7 is disposed between the partition wall 3 and the rear substrate 2 in FIG. 1, the electrode 7 may be disposed in the other position as long as the position is close to the partition wall 3 (for example, in the interior of the partition wall 3). One can use a conductive layer formed by a vacuum deposition method as this second electrode 7, but an electrode formed by an electroplating method is preferable.

The insulating liquid 4 may be a transparent, non-polar solvent such as isoparaffin, silicon oil and xylene and toluene. If necessary, the refractive index may be adjusted by mixing a liquid of high refractive index.

For the charged particles 5, a colored material that shows good electrostatic characteristics of positive or negative polarity in the insulating liquid may be used. For example, various types of inorganic pigments, organic pigments, carbon black and resin including these may be used. The particle size is usually about 0.01 μm to 50μm, preferably about 0.1 μm to 10 μm.

A charge-controlling agent may be added in the insulating liquid or the charged particles to control and stabilize the electrostatic charge of the charged particles. As such a charge controlling agent, metal complex salt of monoazo dye, salicylic acid, organic quaternary ammonium salt, nigrosine compound and the like can be used.

Further, a dispersing agent for preventing the aggregation of charged particles and maintaining the dispersed state thereof may be added in the insulating liquid. As such a dispersing agent, phosphate polyvalent metallic salt such as calcium phosphate, magnesium phosphate and the like, carbonate such as calcium carbonate and the like, other inorganic salt, inorganic oxide, organic polymer material and the like can be used.

The light scattering layer 8 can be prepared, for example, by coating a pigment such as titanium oxide, aluminum oxide and the like dispersed in a resin such as urethane, phenol, epoxy, fluorine and the like. The thickness of the light scattering layer is not necessarily limited insofar as the driving voltage applied to the insulating liquid will not increase. However, in order to attain sufficient light scattering performance, the thickness is preferably 0.4 μm to 20 μm.

For the shielding layer 9, carbon black, inorganic pigment, organic pigment etc. dispersed in resin can be used. The shielding layer can be formed by a conventional method such as vapor deposition, printing, coating and the like. The film thickness is preferably about 1 μm so as to provide sufficient light absorption performance.

Further, when color display is desired, a color filter layer may be provided above the light scattering layer 8 or below the display substrate 1 for each pixel.

Further, a switching element 11 may be disposed for each pixel, and electrically connected to the first electrode 6. The switching element 11 is preferably connected to the bottom of the first electrode 6, and the second electrode 7 of each pixel is preferably connected to each other so as to be provided with the same signal.

According to one embodiment of the present invention, an electrophoretic display device having a high reflectance and a wide angle of visibility performance can be realized. Specifically, by adjusting the refractive indexes of the insulating liquid and the partition wall, the reflectance of white in black and white display can be enhanced, so that the electrophoretic display device having a good contrast and an excellent angle of visibility performance can be realized.

Further, when a color filter is disposed, an excellent color display is achieved without affecting good contrast and angle of visibility performance.

In this embodiment, the shielding layer is not disposed on the outer surface of the display substrate, and shielding is performed by the region where the second electrode 7 is disposed (see reference numeral 9). Hence, the image display is hardly affected by the angle of visibility, nor the angle of visibility of the reflection light is narrowed.

The present invention will be further described below in detail along with the embodiment.

### EXAMPLE 1

In this Example, an electrophoretic display device of a structure as shown in FIG. 1 was prepared. The size of the electrophoretic display device was 52 mm×52 mm, and the number of pixels was 130×43 pieces, and the size of one pixel was 98 μm×98 μm. Further, the partition wall 3 was disposed at pixel boundary portions so as to enclose each pixel. The width of the wall was 5 μm, and the height thereof was 17 μm. Further, the switching element 11, the insulating layer 12, the first electrode 6 and the light scattering layer 8 were disposed on the rear substrate 2 and the shielding layer 9 was disposed between the second electrode 7 and the partition wall 3. The size of the first electrode 6 was 90 μm×90 μm, and the thickness of the second electrode 7 was 50 μm. For the rear substrate 2, a plastic substrate having a thickness of 0.2 mm was used.

Next, a manufacturing method of the electrophoretic display device according to the present embodiment will be described.

First, a switching element 11 was formed on a rear substrate 2, and an insulating layer 12 was formed so as to cover the switching element 11. In this insulating layer 12, a contact hole was bored, and a first electrode 6 was formed so as to be electrically connected to the switching element 11 through this contact hole. The first electrode 6 was formed with aluminum.

Then a light scattering layer 8 was formed by a spin coat method on the whole surface of the substrate so as to cover this first electrode 6. For this light scattering layer 8, a urethane resin layer containing titanium oxide particles was used, and its film thickness was 4 μm.

Further, on the surface of this light scattering layer 8, a second electrode 7 made of titanium was formed on the areas corresponding to the pixel boundaries, and on the surface of the second electrode 7, a shielding layer 9 was formed. For this shielding layer 9, a resin (product name: CFPR BK series, manufactured by Tokyo Ohka Kogyo Co. Ltd.) containing carbon black was used, and its film thickness was 1 μm.

On the shielding layer 9, a partition wall 3 was formed by patterning. For this partition wall 3, an epoxy resin, a transparent photosensitive resin having a refractive index of 1.50, was used.

Next, the sunken regions surrounded by the partition wall 3 were filled with an insulating liquid 4 and charged particles 5. The insulating liquid as a dispersion medium was prepared as follows: 100 parts by weight of isoparaffin being an aliphatic hydrocarbon solvent (product name: ISOPAR H, manufactured by Exxon Corp.), 0.8 part by weight of styrene butadiene copolymer (product name: ASAPRENE 1205, manufactured by Asahi Chemical Industry Co. Ltd.), 2.5 parts by weight of rosin ester (product name: NEOTALL 125H, manufactured by HARIMA CHEMICALS INC.), 0.012 part by weight of octenoic acid zirconium (product name: NIKKA OCTICS ZIRCONIUM, manufactured by Nippon Chemical Industrial), and polyethylene wax (product name: AC6, manufactured by Tomen Plastic Co. Ltd.) were mixed and stirred for 24 hours. The refractive index of this insulating liquid 4 was 1.42.

For the charged particles 5, polymethyl methacrylate containing 10% by weight of carbon having an average particle size of 2 μm was used. A dispersion liquid (insulating liquid) for the electrophoretic display device was prepared by mixing and dispersing the above-described liquid and the charged particles to fill the sunken regions surrounded by the partition wall 3.

After that, the display substrate 1 and the partition wall were tightly contacted, and the periphery of both substrates was sealed in a state where bubbles were eliminated.

The display device prepared by the above-described method was not affected by the driving voltage and the like of the adjacent pixel, and was able to display in black and white with excellent contrast. Further, even when the substrate was bent, the damage to the partition wall etc. or the migration of the charged particles to the adjacent pixel was prevented.

Next, when the reflectance of the display device at the angle of visibility of 0° was measured under the temperature of 22° C., it was as good as 45%.

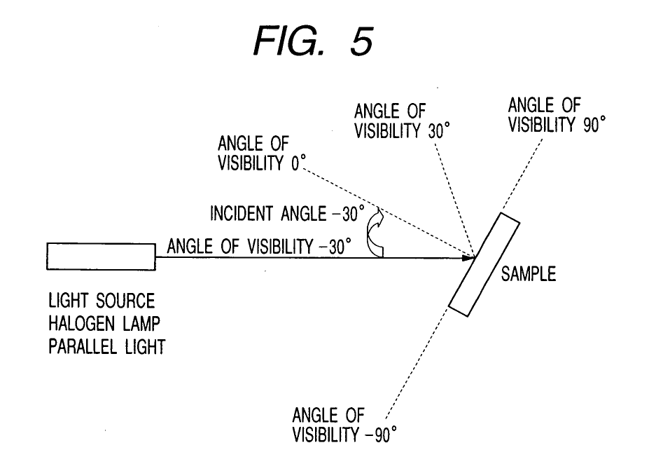

For the measurement of reflectance and angle of visibility performance of the reflectance, an automatic variable angle photometer GP-200 (manufactured by Murakami Color Research Laboratory) was used. As shown in FIG. 5, parallel rays were radiated at an incident angle of 30° to the display surface, and reflectance was measured within the range of −90° to 90° of the angle of visibility to determine the value at 0° as a representative value. The value of the reflectance was calculated using the reflectance of a standard white board of barium sulfate as 100%.

Further, for the measurement of the refractive index of the liquid, a hand-held refractometer R-5000 (a product of ATAGO) with refractive index measurement range from 1.33 to 1.52 was used, and for the measurement of the refractive index of a polymer film, the Abbe refractometer 4T for high refractive index measurement (a product of ATAGO, refractive index measurement range from 1.47 to 1.87) was used.

### EXAMPLE 2 (REFERENCE EXAMPLE)

A display device was prepared in the same manner as in Example 1, except that in the dispersion medium, 1-bromnaphthalene having a high refractive index (refractive index 1.66) was mixed to make the refractive index of the liquid 1.59. The film thickness of the light scattering layer 8 was 4 μm, and the refractive index of the partition wall 3 was 1.50.

In this case, the reflectance was estimated by a computer simulation. Expected reflectance is as high as 43%. However, such a high refractive index liquid is not practical, so this Example is only for reference.

### EXAMPLE 3

A simulation calculation was carried out using the parameters as in Example 1 except that the same 1.42 was used for the refractive index of the partition wall 3 and that of the insulating liquid, with the film thickness of the light scattering layer 8 of 4 μm.

The reflectance derived from a computer simulation was as high as 42%.

### EXAMPLE 4

In this Example 4, a display device was assumed to be the same as in Example 1, except that the film thickness of the light scattering layer 8 was 9 μm.

The expected refractive index estimated by a computer simulation was as high as 56%.

### COMPARATIVE EXAMPLE 1

A display device as a comparative example was assumed to be the same as in Example 1, except that the reflactive index of the partition wall is 1.59.

The expected refractive index estimated by a computer simulation was as high as 35%.

### COMPARATIVE EXAMPLE 2

Another comparative example was assumed to be the same device as the comparative example 1, except that the film thickness of the light scattering layer 8 was 1 μm.

The expected refractive index estimated by a computer simulation was as high as 33%.

The above-described Examples 1 to 4 and Comparative Examples 1 and 2 described below are summarized in the table.

TABLE 1

| | | | Refractive |
|---|---|---|---|
| | | Conditional | index |
| | Constitution | Formula 2 | (%) |
| Embodiment 1 | Partition = 1.50 | Satisfied | 45 |
| | wall n (K) | | |
| | Liquid n (L) = 1.42 | | |
| | Light 4 μm | | |
| | scattering | | |
| | layer film | | |
| | thickness | | |
| Reference | Partition = 1.50 | Satisfied | 43 |
| example 2 | wall n (K) | | |
| | Liquid n (L) = 1.59 | | |
| | Light 4 μm | | |
| | scattering | | |
| | layer film | | |
| | thickness | | |
| Embodiment 3 | Partition = 1.42 | Satisfied | 42 |
| | wall n (K) | | |
| | Liquid n (L) = 1.42 | | |
| | Light 4 μm | | |
| | scattering | | |
| | layer film | | |
| | thickness | | |
| Embodiment 4 | Partition = 1.50 | Satisfied | 56 |
| | wall n (K) | | |
| | Liquid n (L) = 1.42 | | |
| | Light 9 μm | | |
| | scattering | | |
| | layer film | | |
| | thickness | | |
| Comparative | Partition = 1.59 | Not | 35 |
| example 1 | wall n (K) | satisfied | |
| | Liquid n (L) = 1.42 | | |
| | Light 4 μm | | |
| | scattering | | |
| | layer film | | |
| | thickness | | |
| Comparative | Partition = 1.59 | Not | 33 |
| example 2 | wall n (K) | satisfied | |
| | Liquid n (L) = 1.42 | | |
| | Light 1 μm | | |
| | scattering | | |
| | layer film | | |
| | thickness | | |

From these results, one can understand that, if the conditional formula 2 is satisfied, the refractive index of not less than 40% can be achieved without causing a total reflection in the partition wall.

Further, with every Example, the reflectance within the angle of visibility from −30° to +10° is almost the same as that at 0°. On the other hand, with comparative examples 1 and 2, the angle where the reflectance is almost the same as that at 0° is as narrow as −20° to 0°.

The present invention can be adapted to a color display device. Color filer layers of different colors (product name: RED: CR-8960L, GREEN: CG-8960L, BLUE: CB-8960L manufactured by FUJIFILM ARCH CO. LTD.) were formed on the light scattering layer for every pixel area having the size of 6.5 mm×6.5 mm×⅓ mm. The thickness of this color filter was 1 μm. The constitution and the manufacturing method other than this was the same as that of Example 4, that is, an epoxy resin having a refractive index of 1.50 was used for the partition wall, and the insulating liquid had a refractive index of 1.42, and the film thickness of the light scattering layer was 9 μm.

1. A display device comprising:
a display substrate and a rear substrate disposed with a space;
a transparent liquid disposed in the space between these substrates;
a partition wall formed from a material capable of transmitting light and disposed in the space between the substrates;
a light shielding layer disposed between the partition wall and the rear substrate; and
a light scattering layer disposed on the rear substrate capable of reflecting an incident light from outside the display substrate,
characterized in that a refractive index of the partition wall is no less than that of the transparent liquid, and an incident light ray on the display substrate at a predetermined incident angle or more that enters inside the partition wall is not totally reflected but refracted into the transparent liquid at a side face of the partition wall.

2. The display device according to claim 1, wherein the refractive index of said partition wall n(K) and the refractive index of said transparent liquid n(L) satisfy the following condition:
90°−Arc sin [½n(K)]<Arc sin [n(L)/n(K)].

3. The display device according to claim 1, wherein the height of said partition wall H, the width W, and the refractive index n(K), and the refractive index of said transparent liquid n(L) satisfy the following condition:
90°−Arc sin [n(K)sin α]<Arc sin [n(L)/n(K)]
where α is an angle determined by tan
$$α = \frac{W}{H} .$$

4. The display device according to claim 1, wherein the partition wall is formed with a photosensitive resin selected from the group consisting of epoxy, polyimide and acryl.

5. The display device according to claim 1, wherein said transparent liquid includes a plurality of charged particles.

6. The display device according to claim 1, wherein said transparent liquid is a liquid crystal.
